(19) United States
(12) Patent Application Publication
(10) Pub. No.: US 2014/0293343 A1
(43) Pub. Date: Oct. 2, 2014

(54) ORDER MANAGEMENT APPARATUS AND ORDER MANAGEMENT METHOD

(71) Applicant: CANON KABUSHIKI KAISHA, Tokyo (JP)

(72) Inventor: Namihiro Mori, Kawasaki-shi (JP)

(21) Appl. No.: 14/226,568

(22) Filed: Mar. 26, 2014

(30) Foreign Application Priority Data
Mar. 28, 2013 (JP) 2013-070538

(51) Int. Cl. G06F 3/12

(52) U.S. Cl. CPC G06F 3/1263; G06F 3/1203; G06F 3/1275
USPC 358/1.15

(57) ABSTRACT

An order management apparatus is configured to receive order data, to register the order data, to issue an instruction to produce a product based on the registered order data according to scheduling set by an administrator, to determine whether a process that does not require an operation by an operator is included in the processes for producing the product based on the order data, and to issue an instruction to start a process with production of the product based on the order data removed from a target of the scheduling if it is determined that the process that does not require an operation by an operator is included.

### BACKGROUND

1. Technical Field

The present disclosure relates to an order management apparatus and an order management method used when handling a product order in which the processing content, which includes a plurality of processes, is defined.

2. Description of the Related Art

In the commercial printing industry, there is an increasing trend toward ordering of small lot jobs with high added value and toward a shorter delivery time period. Consequently, in addition to the offset printing machines and the post-processing machines for bookbinding and the like that have been conventionally used, the introduction of print-on-demand (POD) devices is actively progressing. One advantage of POD devices is that a series of processing steps, such as print processing and post-processing on a printed product, can be automatically performed based on the job. Further, in some cases of the commercial printing, workflow management is performed using a management information system (MIS) for order management, production management, and collection of job performance information for various products. The aim of introducing MIS is to increase work efficiency by managing a plurality of products in a unified manner, decrease costs by managing time, and grasp and eliminate waste by managing performance. A typical workflow at a printing base that employs MIS has a flow in which, among the orders received by the MIS, scheduling is performed regarding when and what time production is to be performed, and based on that schedule, the production is started and each process is executed and controlled. As an example of conventional technique, Japanese Patent Application Laid-Open No. 2004-310746 discusses a technique for controlling the processes in which a print job and a printing instruction are received, a plurality of processes for the print job is controlled, and the processes are managed by scheduling each process.

However, in Japanese Patent Application Laid-Open No. 2004-310746, it is impossible to execute each process unless an operator has performed scheduling of the processes, regardless of whether each process requires an operation by an operator. Consequently, an operator has to wait for the completion of a process that does not require an operation by operator before he/she can execute a process that does require an operation by the operator, which causes an increase in the operation time (overhead time).

The present disclosure is directed to resolving this problem.

### SUMMARY

According to an aspect of the present invention, an order management apparatus for handling a product order in which processing content of a plurality of processes is defined includes a receiving unit configured to receive order data, a registration unit configured to register the order data received by the receiving unit, and an instruction unit configured to issue an instruction to produce a product based on the order data registered in the registration unit according to scheduling performed by an administrator, wherein the instruction unit is configured to determine whether a process that does not require an operation by an operator is included in the processes for producing the product based on the order data, and if it is determined that a process that does not require an operation by an operator is included, to issue an instruction to start the process with production of the product based on the order data removed from a target of the scheduling.

Further features of the present invention will become apparent from the following description of exemplary embodiments with reference to the attached drawings.

### BRIEF DESCRIPTION OF THE DRAWINGS

FIG. 1 is a block diagram illustrating an example of a production system configuration according to an exemplary embodiment.

FIG. 2 is an example of a block diagram illustrating an internal configuration of an order management apparatus.

FIG. 3 is a diagram illustrating an example of a folder structure of order data.

FIGS. 4A, 4B, and 4C are tables illustrating examples of the structure of order information, product information, and process information, respectively, managed by the order management apparatus.

FIG. 5 is an example of a screen illustrating a user interface for scheduling by the order management apparatus.

FIG. 6 is a flowchart illustrating an example of a series of processing steps performed by the order management apparatus according to a first exemplary embodiment.

FIG. 7 is a flowchart illustrating an example of processing for registering reception of an order performed by the order management apparatus according to the first exemplary embodiment.

FIG. 8 is a flowchart illustrating an example of processing for starting production performed by the order management apparatus according to a second exemplary embodiment.

FIGS. 9A and 9B are diagrams each illustrating an example of a concept of a job queue before and after a change in a priority level in a prepress apparatus according to the second exemplary embodiment.

FIG. 10 is a flowchart illustrating an example of processing performed by the order management apparatus according to a third exemplary embodiment when an error has occurred.

### DESCRIPTION OF THE EMBODIMENTS

Various exemplary embodiments, features, and aspects of the invention will be described in detail below with reference to the drawings.

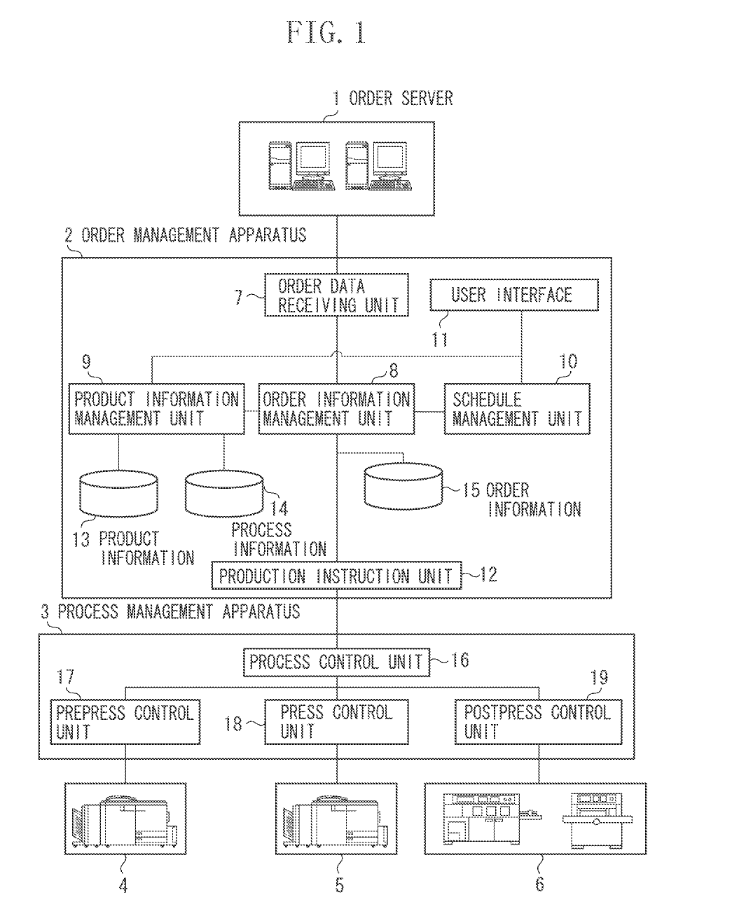

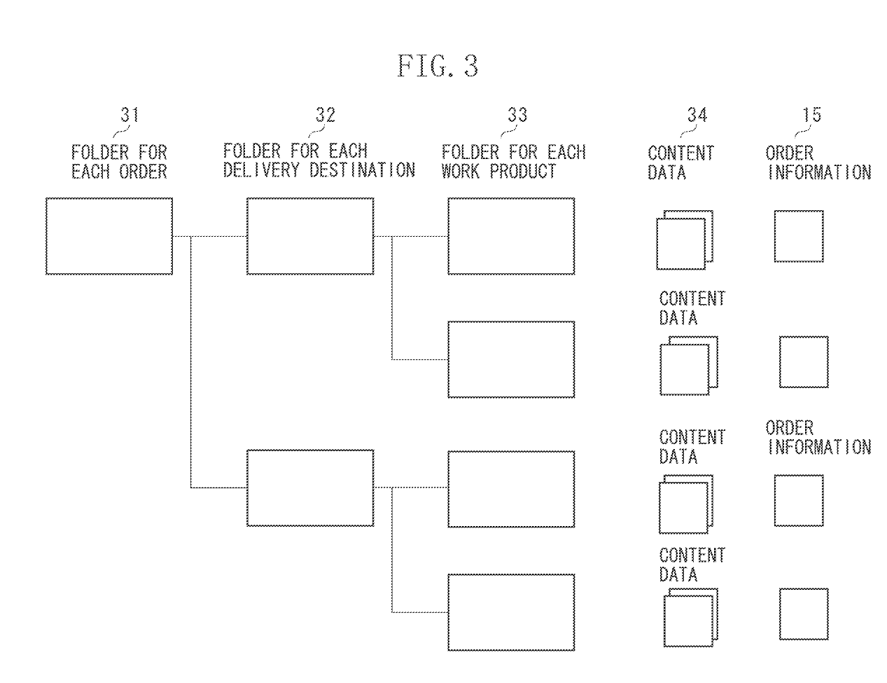

FIG. 1 is a block diagram illustrating an example of a production system configuration according to an exemplary embodiment. The production system includes an order server 1, an order management apparatus 2, a process management apparatus 3, a prepress apparatus 4, a press apparatus 5, and a postpress apparatus 6. The order server 1 is a server apparatus mainly configured to manage orders made by a user. When the user inputs order content for a product or uploads target content and confirms an order, the order server 1 generates various kinds of data about the order made by the user. The order data will be described below in more detail with reference to FIG. 3. Further, there is a plurality of order servers 1 based on the type of product. These order servers 1 are connected with the order management apparatus 2 via the Internet. The order management apparatus 2 receives order data from the order server 1, and provides an administrator of a printing base with a function for managing order information and production of products. The order management apparatus 2 includes an order data receiving unit 7, an order information management unit 8, a product information management unit 9, a schedule management unit 10, a user interface 11, and a production instruction unit 12. The process management apparatus 3 is configured to control and manage the various processes that are executed when producing a product. The process management apparatus 3 includes a process control unit 16, a prepress control unit 17, a press control unit 18, and a postpress control unit 19. The prepress apparatus 4 is configured to interpret a prepress job transmitted via the prepress control unit 17 and actually performs the pre-processing of the content data to be printed. Prepress refers to the processing that is performed before press processing. Examples of the prepress include content editing processing, imposition processing, image processing and the like. Further, when using an offset printing machine, processing such as plate making for creating the plates in order to perform printing is also defined as the prepress processing. As an example of the apparatus type, the prepress apparatus 4 includes a plate making apparatus. Further, the prepress apparatus 4 is not limited to a dedicated apparatus, and may also be realized by software in a personal computer (PC). The press apparatus 5 interprets and prints a press job transmitted via the press control unit 18. The postpress apparatus 6 is configured to interpret a postpress job transmitted via the postpress control unit 19, to set a post-processing parameter, and to perform post-processing of a printed product at a timing when the printed product is set thereon. As examples of the apparatus type, the postpress apparatus 6 includes a case binding machine, a cutting machine, a ribbing machine, a laminator and the like.

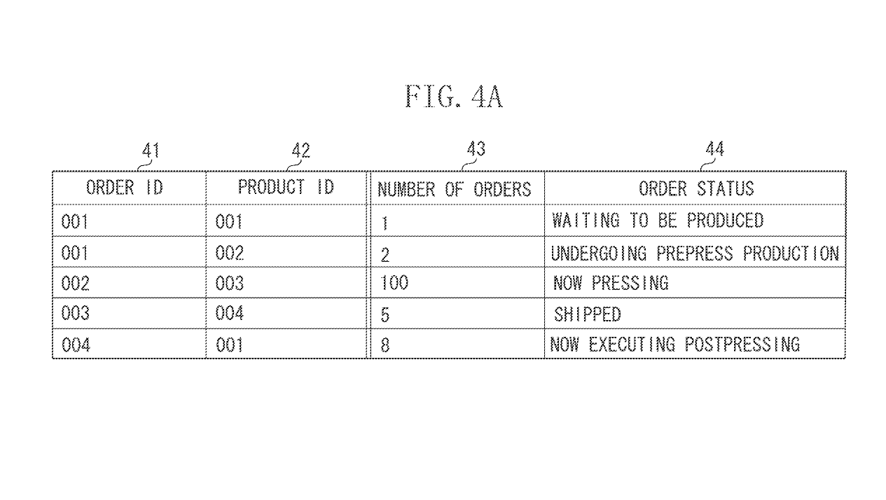

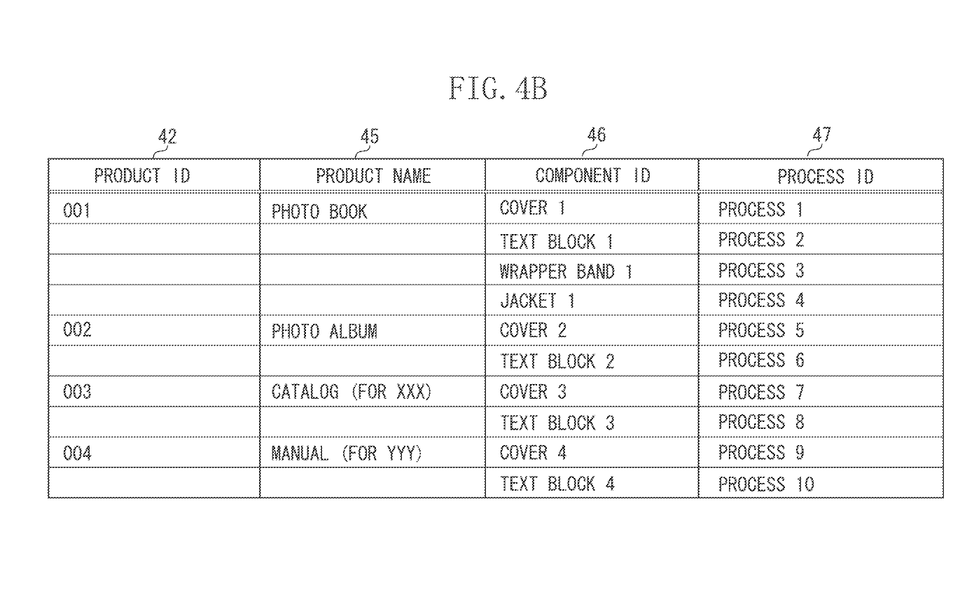

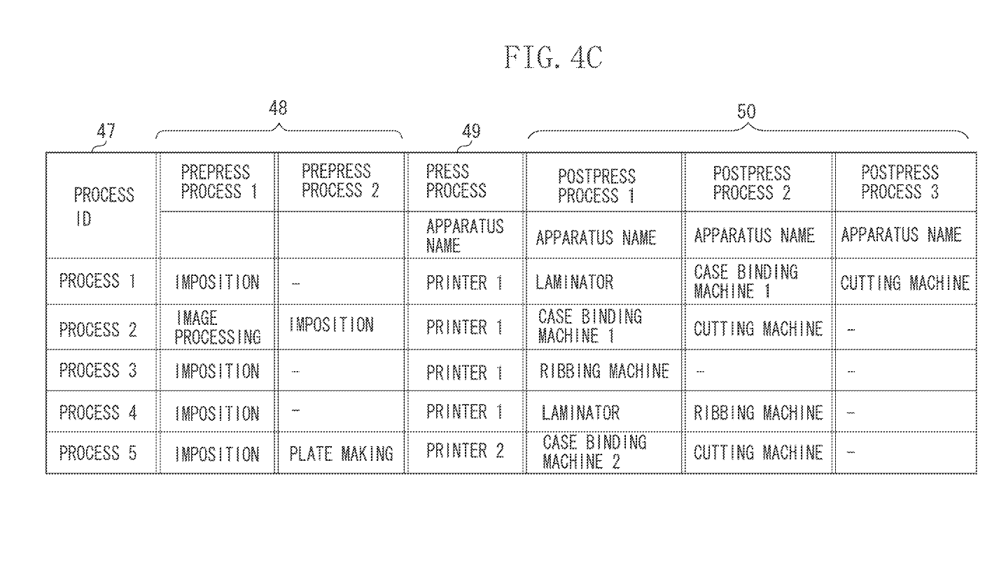

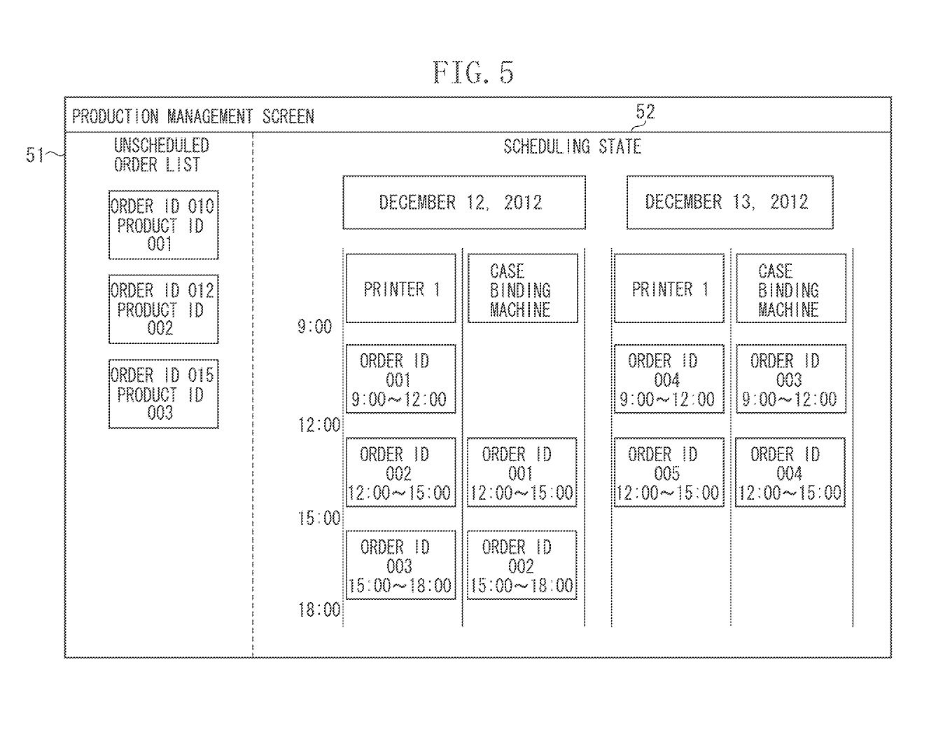

Next, each of the constituent elements of the order management apparatus 2 will be described below. The order data receiving unit 7 has a function of receiving order data from the order server 1. The order information management unit 8 has a function of managing the order data received by the order data receiving unit 7. The structure of the managed order information will be described below in detail with reference to FIG. 4. The product information management unit 9 has a function of managing information relating to the products handled by the order management apparatus 2. There are two pieces of information managed by the product information management unit 9, product information 13 and process information 14. The structure of these two pieces of information will be described below in detail with reference to FIG. 5. The schedule management unit 10 has a function of managing a schedule of the order information specified by the user, namely, managing the planned production state of each process for each order. The user interface 11 is a graphical interface for displaying a list of the received and registered orders and allowing a user to perform scheduling of production, an instruction of a production start, and various settings. The user interface 11 will be described below in more detail with reference to FIG. 5. The production instruction unit 12 has a function of acquiring the instructions to the process management apparatus 3 and acquiring a status from the process management apparatus 3 regarding the orders for which an instruction to start production has been issued.

Next, each of the constituent elements of the process management apparatus 3 will be described below. The process control unit 16 has a function of receiving instructions from the production instruction unit 12 in the order management apparatus 2, issuing instructions to the control units for the respective processes, acquiring a status from the control units for the respective processes, and performing control of each process. The prepress control unit 17, the press control unit 18, and the postpress control unit 19 have a function of controlling the prepress apparatus 4, the press apparatus 5, and the postpress apparatus 6, respectively.

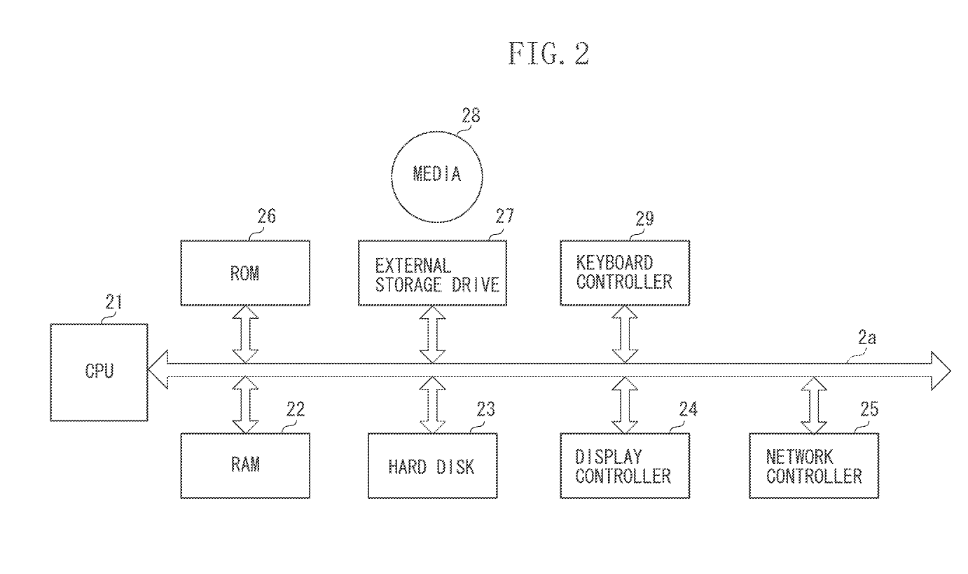

FIG. 2 is an example of a block diagram illustrating an internal configuration of the order management apparatus 2. A central processing unit (CPU) 21 corresponding to a computer executes programs stored in a program area in a read-only memory (ROM) 26, or programs, such as an operating system (OS) or a multipurpose application, loaded from a hard disk 22 in a random-access memory (RAM) 22. The RAM 22 functions as a main memory and a work area of the CPU 21. The hard disk 23 stores a boot program, various applications, font data, user files, electronic document files and the like. Further, all of the order data received by the order management apparatus 2 is transmitted to the hard disk 23. A display controller 24 controls the display on a display device. A network controller 25 executes communication control processing with other devices that are connected to a network. An external storage drive 27 stores information received from portable media 28, such as a compact disc (CD) and a digital versatile disc (DVD). A keyboard controller 29 controls key input from a keyboard and a pointing device. Further, the CPU 21 is connected by an internal bus 2a to each block.

FIG. 3 illustrates an example of a folder structure of the order data. The order server 1 generates one order folder for each order made by the user. The order folder includes a folder 31 for each order, a folder 32 for each delivery destination, and a folder 33 for each product. The folder 31 for each order serves as a root folder of the order data. If an order has a plurality of delivery destinations, the folder 31 for each order has a plurality of folders 32 for each delivery destination. A folder 32 is generated for each delivery destination. If an order is issued for a plurality of types of products to be delivered to a certain delivery destination, then the order has a plurality of folders 33 for each product. The folder 33 for each product is a folder that includes the order data of a certain product. Even for the same type of product, for example, if the product content such as the size or content data is different, the folders 33 for each product are handled as separate folders.

Further, the order data includes order information 15 and content data 34. The order information 15 is data in which information about an order and a product that has been set when the user made an order is described. The content data 34 is the content to be printed. Depending on the product, there may be a plurality of content data. For example, for an order to create a photo album, there are two pieces of content data, i.e., content data for the cover and content data for the text block.

FIGS. 4A, 4B, and 4C are tables illustrating examples of the structure of the order information 15, the product information 13, and the process information 14 managed by the order management apparatus 2, respectively. FIG. 4A illustrates an example of the structure of the order information 15. As described above with reference to FIG. 3, the order information 15 includes data in which information about an order and a product that has been set when the user made an order is described. The order information 15 includes an order ID 41, a product ID 42, order content 43, and an order status 44. The order ID 41 represents an identifier for uniquely identifying the order information. However, if a certain order includes orders for a plurality of products, these products have the same identifier of the order ID 41. In the table illustrated in FIG. 4A, there are two orders with “001” of the order ID 41. Therefore, it can be understood that these two orders were made simultaneously. Next, the product ID 42 represents an identifier for uniquely identifying the product information 13. With the product ID 42, a determination can be performed regarding what product each order relates to. The order content 43 is information about what kind of content a received order has. Examples of the order content 43 include the number of orders. The order status 44 includes information about the current state of an order relating to a target product. Examples of the order status 44 include waiting to be registered, waiting to be produced, now being produced, shipped and the like. Waiting to be registered is a state in which, although the order data has been received, the order data is not registered under the management of the order management apparatus 2, so that the order is not in a state in which scheduling and production can start. Waiting to be produced is a state in which, although the order management apparatus 2 has received the order, an instruction to start production has not yet been issued, so that the order is waiting for scheduling and an instruction for production to start from the user. Now being produced is a state in which an instruction to start production has been issued from the user, and production in a certain process is now being executed. Shipped is a state in which the execution of each process has been completed, and the shipping of the product to the delivery destination has been completed.

FIG. 4B illustrates an example of the structure of the product information 13. The product information 13 includes a table for managing what type of product the system is designed to produce. This information is registered when the system is built. In the table of the product information 13, a product ID 42, a product name 45, a component ID 46, and a process ID 47 are included. The product name 45 represents the name corresponding to the product ID 42. It is desirable to select the product name 45 in consideration of use for displaying via the user interface 11 for the user of the application. For example, a name that allows the user to understand what type of product it represents, such as “catalog (for XXX)” or “photo album”, is desirable. The component ID 46 is an identifier that allows the components configuring a certain product to be uniquely identified. For example, although a poster is configured from one component, a product, such as a booklet or an album, is configured from a plurality of components. Examples of component types include a cover, a text block, a wrapper band, a jacket and the like. The process ID 47, which is an identifier that allows the type of processes required to produce the product to be uniquely identified, is defined for each component ID of a product.

FIG. 4C illustrates an example of the structure of the process information 14. The process information 14 includes a table for managing the content and the sequence of the production processes for each component configuring a product. In the table of the process information 14, a process ID 47, a prepress process content 48, a press process content 49, and a postpress process content 50 are includes. The prepress process content 48 is a name representing the content and the sequence of processes relating to prepress processing. In the table illustrated in FIG. 4C, processes 1, 3, and 4 are defined as a process in which imposition processing is performed as a prepress process. Process 2 is defined as a process in which imposition processing is performed after image processing has been performed. Process 5 is defined as a process in which plate making processing is performed after imposition processing has been performed. The press process content 49 represents the content of a process relating to press processing. In the table illustrated in FIG. 4C, the name of the press apparatus to be used in the press process is defined. The postpress process content 50 represents the content and sequence of postpress processing. In the table illustrated in FIG. 4C, process 1 is defined as a process for performing processing in a sequence of laminating processing, case binding, and cutting. Process 2 is defined as a process for performing case binding and cutting.

FIG. 5 illustrates an example of the user interface 11 during scheduling by the order management apparatus. The user interface 11 is designed based on the assumption that the administrator of a printing base is viewing and operating the screen when performing scheduling for when and with which device each order is to be produced after the received order data has been registered. The user interface 11 includes two panes, an unscheduled order list pane 51 and a scheduling state pane 52. The unscheduled order list pane 51 is a pane in which a list of the order data that has not yet been scheduled is displayed. It is desirable that the unscheduled order data is displayed per product as the scheduling units. The scheduling state pane 52 is a pane in which the scheduling state of the order data is displayed. The scheduling state is displayed in units of one day, and scheduling is performed for each device. In the user interface 11 illustrated in FIG. 5, on Dec. 12, 2012, printing is scheduled at printer 1 from 9 o'clock to 12 o'clock for the data with the order ID “001”, from 12 o'clock to 15 o'clock for the data with the order ID “002”, and from 15 o'clock to 18 o'clock for the data with the order ID “003”. The assumed procedure of the operator (i.e., the administrator of the printing base) is as follows. First, the operator views the unscheduled order list pane 51, and confirms the number of pieces and the content of the received order data that has been registered but not yet scheduled. After confirming the data, the operator views the scheduling state pane 52, and confirms the availability of each device. Then, based on device availability, the operator arranges the required number of pieces of unscheduled order data in the scheduling state pane 52. Consequently, the administrator of the printing office can manage the production of a plurality of products in an integrated manner, while also improving device operating efficiency and reducing costs by managing the operation time of each device.

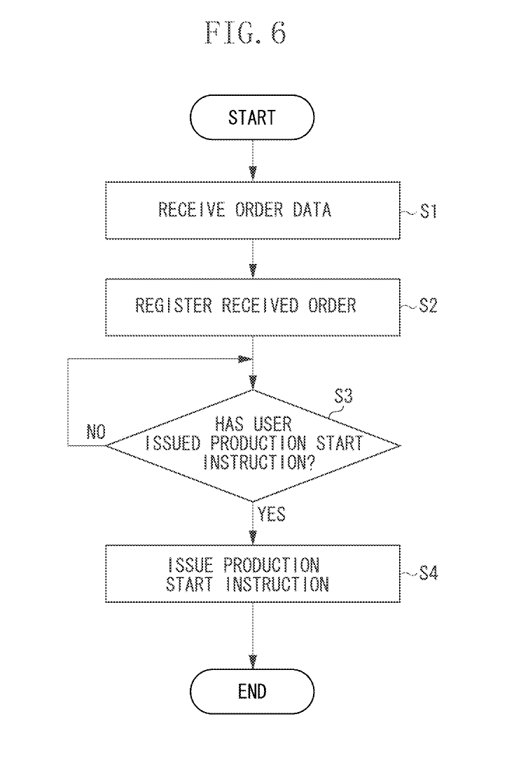

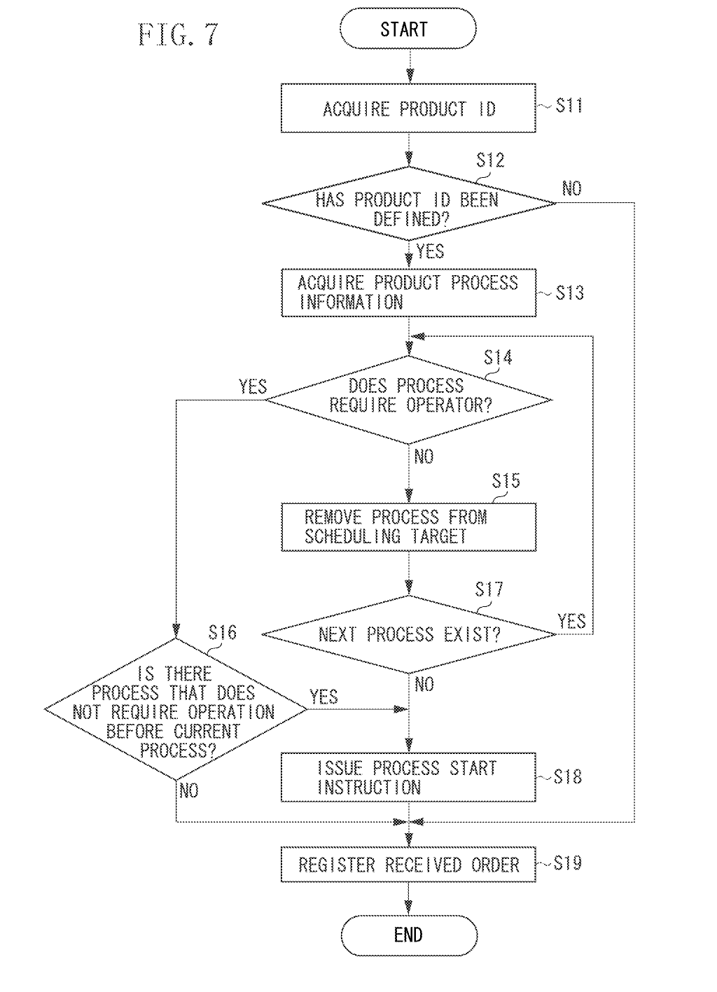

Next, an example of the series of processing steps performed by the order management apparatus 2 according to a first exemplary embodiment will be described with reference to the flowchart illustrated in FIG. 6. The program according to this flow is stored in the hard disk 23 of the order management apparatus 2, read by the RAM 22, and executed by the CPU 21. First, in step S1, the order data receiving unit 7 receives order data transmitted by the order server 1. The number of pieces of order data, as described with reference to FIGS. 3 and 4A, that are received corresponds to the number of times that an order was made by the user. Next, in step S2, the order information management unit 8 registers each received piece of order data. The flow of registering the received orders will be described below in more detail with reference to FIG. 7. Orders that have completed the process in step S2 are displayed in the unscheduled order list pane 51 of the user interface 11 illustrated in FIG. 5, which enables the administrator of the printing base to view an order data list, perform scheduling production of the order data, and issue an instruction to start production. Next, in step S3, the user interface 11 acquires an event indicating whether order data has been scheduled or whether an instruction to start production has been issued by the application user. If an event is acquired (YES in step S3), the user interface 11 transmits the content of the order information for which production has started to the production instruction unit 12 via the order information management unit 8. Step S3 is periodically performed until an event occurs. Next, in step S4, the production instruction unit 12 issues an instruction to start production to the process control unit 16. Then, the process control unit 16 performs control to execute the processes defined for each component of the product. For example, if the product ID 42 of the received order data is a photo book of the order ID “001”, the process control unit 16 controls the execution of the processes defined for the four components forming the photo book, which are the cover, the text block, the wrapper band, and the jacket. Namely, the process control unit 16 issues an instruction to perform image processing of the text block and an instruction to execute imposition of each component to the prepress control unit 17, an instruction to execute printing to the press control unit 18, and an instruction to execute bookbinding, cutting, ribbing, and laminating to the postpress control unit 19, respectively. Further, the process control unit 16 controls each process based on the process sequence. For example, after notification that imposition, which is a prepress process, has been completed has been received from the prepress control unit 17, the process control unit 16 issues the execution instruction for the next process to the press control unit 18.

FIG. 7 is a flowchart illustrating an example of the processing for registration of received orders performed by the order management apparatus 2 according to the first exemplary embodiment. This flowchart will be described below using an example in which an order with the order ID “001” that is illustrated in FIG. 4A is handled as order data. First, in step S11, the order information management unit 8 stores the information included in the order data in the order information 15, and acquires the product ID 42 in the order information 15. In the table illustrated in FIG. 4A, the order ID 42 includes two types of the product ID of “001” and “002”. Next, in step S12, the order information management unit 8 determines whether the product ID 42 acquired in step S11 is for a product that has already been defined in the order management apparatus 2. Specifically, the order information management unit 8 performs this determination by acquiring a list of the product IDs that are registered in the product information 13 managed by the product information management unit 9, and comparing with the product ID included in the order information 15. If it is determined that the product has not yet been defined (NO in step S12), the processing proceeds to step S19. In step S19, the received order is registered as another product. If it is determined that the product has already been defined (YES in step S12), the processing proceeds to step S13. In the present exemplary embodiment, since each product ID 42 is defined in the product information 13, the processing proceeds to step S13. In step S13, the order information management unit 8 acquires the process information about the product. Specifically, the order information management unit 8 transfers the product ID 42 acquired in step S11 to the product information management unit 9. The product information management unit 9 searches the product information 13, acquires a process ID 47 that corresponds to a component ID 46 forming the product of the transferred product ID 42, and acquires the process information registered in the process information 14 by using the process ID 47 as a key. In this example of the present exemplary embodiment, since the product with the product ID “001” is configured from four components, processes 1 to 4 can be acquired, while since the product with the product ID “002” is configured from two components, processes 5 and 6 can be acquired. In the following steps, the processing proceeds for each of the acquired steps. In this example of the present exemplary embodiment, since there is a total of six processes in one order, the processing from step S14 onwards is performed six times.

Next, in step S14, the order information management unit 8 determines, for one of the processes among the process information acquired in step S13, whether that process requires an operation by an operator. The determination whether a process requires an operation by an operator may be performed by referring to a flag included in the process information 14 indicating that an operation by an operator is not required, or may be automatically performed by the program based on the type and content of the process and an association with other processes. A case in which determination is automatically performed based on an association with other processes is described in the following. For example, the prepress processes with both of the product IDs “001” and “002” include imposition processes. In the case of product ID “002”, it is determined that an operation by an operator is required since a plate making process is included in the processes after imposition. If it is determined that the process does not require an operation by an operator (NO in step S14), the processing proceeds to step S15. In step S15, that process is removed from the scheduling target, and the processing proceeds to step S17. If it is determined that the process requires an operation by an operator (YES in step S14), the processing proceeds to step S16. In the above described example, since it was determined that none of the prepress processes of the process with the product ID “001” require an operation by an operator, the process with the product ID “001” is removed from the scheduling target. Further, since it was determined that the process with the product ID “002” requires an operation by an operator, all of the processes become a scheduling target. In step S16, the order information management unit 8 determines whether there is a process that does not require an operation by an operator in one order. If it is determined that there is no process that does not require an operation by an operator (NO in step S16), the order information management unit 8 determines that there are no processes that can be executed before the received order is registered, and the processing proceeds to step S19. In step S19, the received order is registered. If it is determined that there is one or more processes that requires an operation by an operator (YES in step S16), the processing proceeds to step S18. In step S18, the order information management unit 8 issues an instruction to start the process that does not require an operation by an operator. In step S17, the order information management unit 8 determines whether a next process exists. The term next process refers to a process immediately after a process having the same order ID. If it is determined that a next process exists (YES in step S17), the processing returns to step S14, and the order information management unit 8 determines whether the next process is a process that requires an operation by an operator. If it is determined that a next process does not exist (NO in step S17), the order information management unit 8 determines that none of the processes require an operation by an operator, and the processing proceeds to step S18. In step S18, the order information management unit 8 issues an instruction to start all the processes before the received order is registered. Lastly, in step S19, the received order data is registered, and the processing performed in this flowchart is finished.

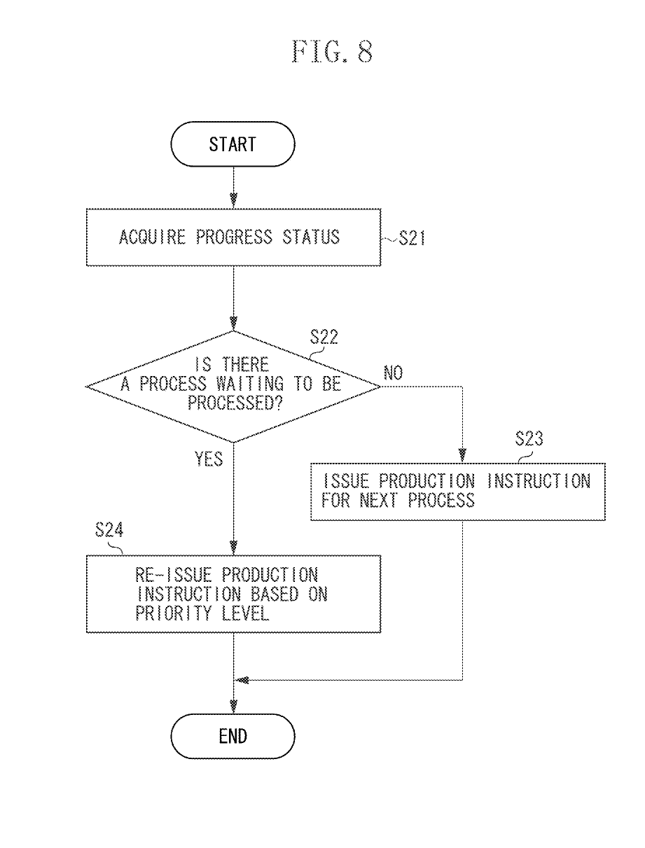

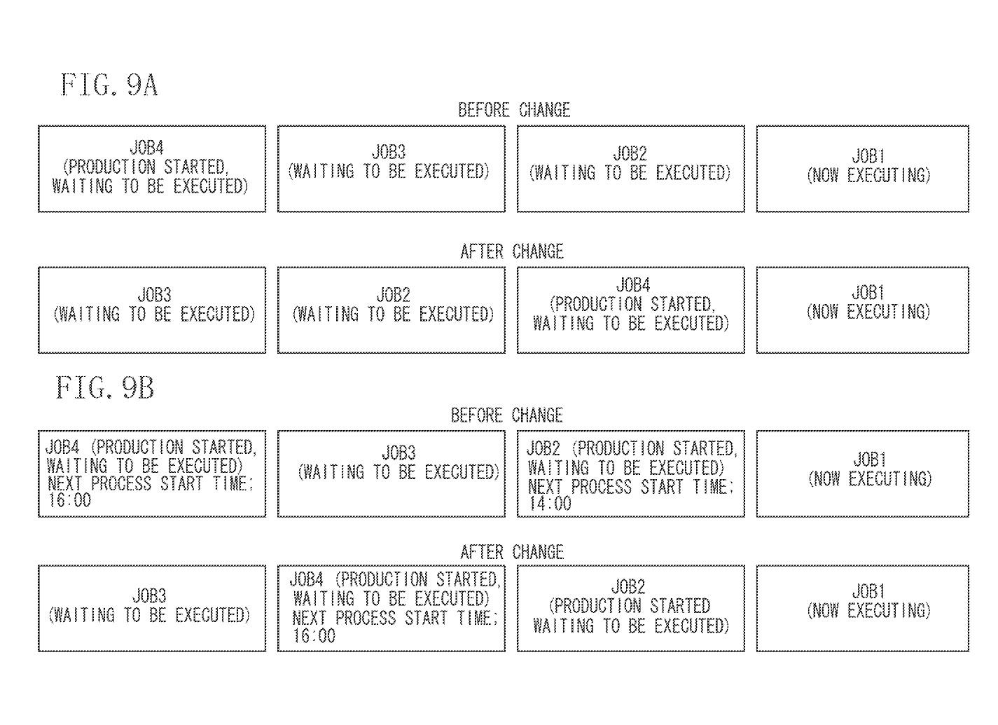

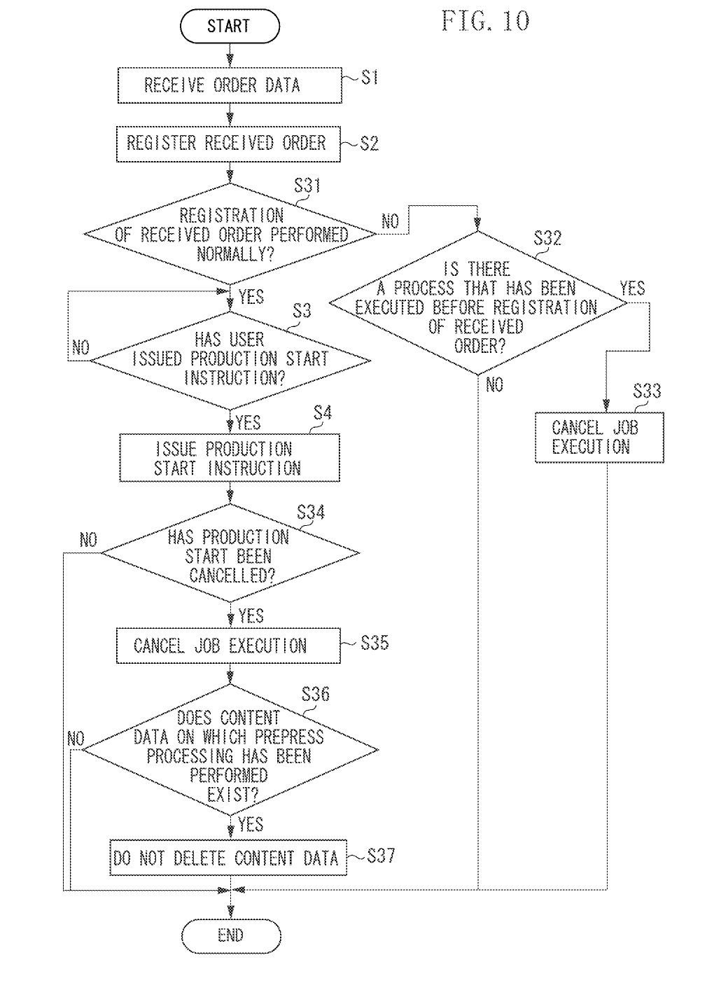

Next, an example of the processing steps in the production start processing performed by the order management apparatus 2 according to a second exemplary embodiment will be described below with reference to the flowchart illustrated in FIG. 8. The following processing steps in the second exemplary embodiment is performed when a production start instruction for an order has been issued from the order management apparatus 2 while it is determined that the imposition process in the received order does not require an operation by an operator, and the execution instruction is issued before the received order is registered. When a production start instruction has been issued from the user, in step S21, the order information management unit 8 acquires the progress status of the order information for which the production start instruction has been issued. Next, in step S22, the order information management unit 8 determines based on the progress status acquired in step S21 whether there is a process for which a production start instruction has already been issued but is waiting to be processed. If it is determined that there are no processes waiting to be processed (NO in step S22), the processing proceeds to step S23. In step S23, the order information management unit 8 issues a production start instruction for the process that is next to the process which has been completed. If it is determined that there is a process waiting to be processed (YES in step S22), the processing proceeds to step S24. In step S24, the order information management unit 8 issues an instruction to the process control unit 16 to increase the priority level of the process that is currently waiting to be processed. This is because the fact that a production start instruction has been issued means that the order data relating to the job currently waiting to be processed needs to be processed earlier than other orders waiting to be processed. This processing will be described below in more detail with reference to FIG. 9. Consequently, operation time can be decreased by increasing the priority level and re-issuing a production start instruction even when a product for which a production start instruction has been issued cannot proceed to the next process because it is waiting to be processed at a process that does not require an operation by an operator.

FIGS. 9A and 9B are diagrams each illustrating an example of a concept of a job queue before and after a change in the priority level for the prepress apparatus 4 according to the second exemplary embodiment. In the case illustrated in FIG. 9A, the prepress apparatus 4 is an apparatus or a program that performs imposition processing. FIG. 9A illustrates an example of a concept of a job queue before and after a change in the priority level when there is only one job that has started production and is waiting to be executed. In FIG. 9A, four jobs, from a job 1 to a job 4, are to be executed by the prepress apparatus 4, and currently the job 1 is being executed. It is presumed that a production start instruction has been issued for the product relating to the job 4. Since the priority level of the job 4 has been increased by the processing performed in step S24 of FIG. 8, after the change, the job 4 is executed after the job 1, which is now being executed, has been completed. Although the job 4 was described as being executed after completion of the job 1 since the job 1 is now being executed, the processing of the job 1 may be temporarily stopped, and the job 4 may be executed.

FIG. 9B illustrates an example of a concept of a job queue before and after a change in the priority level when there is a plurality of jobs that have started production and that are waiting to be executed. In FIG. 9B as well as in FIG. 9A, four jobs, from the job 1 to the job 4, are to be executed by the prepress apparatus 4, and currently the job 1 is being executed. Further, the job 2 is waiting for an imposition process to be executed, and production has started. The order management apparatus 2 has scheduled a planned start time for the next process after the current process at 14:00. It is presumed that a production start instruction has been issued for the order relating to the job 4. However, unlike the case illustrated in FIG. 9A, due to the existence of the job 2, which has already started production, the prepress control unit 17 determines the priority levels of the jobs 2 and 4 based on their planned start time of the next process in the prepress processes. Since the job having the earlier planned start time for its next process needs to have its current process completed first, the job having the earlier planned start time for its next process is given priority and executed. In the case illustrated in FIG. 9B, although both the jobs 2 and 4 have started production, the start time for the next process is 14:00 for the job 2 and 16:00 for the job 4. Therefore, the job 2 is executed before the job 4. Further, since a production start instruction has not been issued for the job 3, the priority level for the job 3 becomes lower than the jobs 2 and 4. Consequently, the job execution order in the prepress apparatus 4 becomes the job 1, the job 2, the job 4, then the job 3. Further, similar to the case illustrated in FIG. 9A, the processing of the job 1 may be temporarily stopped, and the processing of the jobs 2 and 4 may be executed.

Next, an example of the processing that is performed by the order management apparatus 2 according to a third exemplary embodiment when an error has occurred will be described with reference to the flowchart illustrated in FIG. 10. In the third exemplary embodiment, the processing performed by the order management apparatus 2 when an error occurred during registration of the received order data and when a production start instruction is cancelled will be described.

First, when a product order is made, the order management apparatus 2 receives and registers the order data. Since these processing steps are the same as in FIGS. 7 and 8, a description thereof will be omitted here. Then, in step S31, the order information management unit 8 determines whether registration of the received order was performed normally. If it is determined that registration of the received order was performed normally (YES in step S31), the processing proceeds to step S3. If it is determined that registration of the received order was not performed normally (NO in step S31), the processing proceeds to step S32. In step S32, the order information management unit 8 determines whether there is a process for which an execution instruction has been issued before the registration of the received order in step S2. If it is determined that there is no process for which an execution instruction has already been issued (NO in step S32), the order information management unit 8 finishes the processing illustrated in this flowchart without doing anything. However, if it is determined that there is a process for which an execution instruction has already been issued (YES in step S32), a production start instruction cannot be issued because the received order was not successfully registered even though a certain process was due to be executed. Consequently, a mismatch occurs in the management between the order management apparatus 2 and the process management apparatus 3. Therefore, in step S33, the order information management unit 8 transmits an instruction to cancel the process due to be executed to the process control unit 16 via the production instruction unit 12.

Next, the flow when a production start instruction is cancelled by the order management apparatus 2 after the production start instruction was issued will be described. After a production start instruction has been issued in step S4, in step S34, the user interface 11 determines whether an event cancelling the production start has occurred. If production is completed without a cancellation being performed (NO in step S34), the processing illustrated in this flowchart is finished. If a cancellation has been performed (YES in step S34), in step S35, the order information management unit 8 performs cancel processing of the production start, and changes the order status 44. Then, in step S36, the order information management unit 8 acquires whether content data on which prepress processing has been performed exists from the prepress control unit 17 via the process control unit 16. If such content data exists (YES in step S36), in step S37, the order information management unit 8 issues an instruction to the prepress control unit 17 via the process control unit 16 not to delete the content data on which prepress processing has been performed. If this content data is deleted, when an instruction is issued to re-start production of the product for which production start has been cancelled, the processing has to be performed once more from the prepress processes. Therefore, by not deleting the content data, the processing can be executed from a press process without having to again perform the prepress processes that have already been completed. Consequently, operation time can be decreased.

According to the present invention, the production of orders can be scheduled through an order management apparatus and an instruction to execute processes that do not need an operator can be issued before registration of a received order without starting production. Consequently, operation overhead time is decreased, and the workflow can be executed more efficiently.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-070538 filed Mar. 28, 2013, which is hereby incorporated by reference herein in its entirety.

What is claimed is:

1. An order management apparatus for handling a product order in which processing content of a plurality of processes is defined, comprising:
a receiving unit configured to receive order data;
a registration unit configured to register the order data received by the receiving unit; and
an instruction unit configured to issue an instruction to produce a product based on the order data registered in the registration unit according to scheduling performed by an administrator,
wherein the instruction unit is configured to determine whether a process that does not require an operation by an operator is included in the processes for producing the product based on the order data, and if it is determined that a process that does not require an operation by an operator is included, to issue an instruction to start the process with production of the product based on the order data removed from a target of the scheduling.

2. The order management apparatus according to claim 1, wherein if a specific process of the product for which a production instruction has been issued is not completed, an instruction is issued to prioritize processing of the specific process ahead of products that are based on other order data.

3. The order management apparatus according to claim 2, wherein if there is a plurality of orders for which a production instruction has been issued and the specific process is not completed, an instruction is issued to prioritize the specific process having the earliest planned start time for the next process.

4. The order management apparatus according to claim 1, wherein the registration unit is configured to determine whether a process that does not require an operation by an operator is included by acquiring process information corresponding to product information about the order data.

5. The order management apparatus according to claim 1, wherein the registration unit is configured to issue an instruction for a prepress process.

6. The order management apparatus according to claim 1, wherein the registration unit is configured to cancel execution of a process for a product for which a production instruction has already been issued if registration of the order data is unsuccessful.

7. The order management apparatus according to claim 1, wherein if cancellation was performed from the order management apparatus, content data for processes that have already been completed is not deleted.

8. A method for performing order management for handling a product order in which processing content of a plurality of processes is defined, the method comprising:
receiving order data;
registering the received order data;
issuing an instruction to produce a product based on the registered order data according to scheduling performed by an administrator; and
issuing an instruction to start a process with production of the product based on the order data removed from a target of the scheduling if the process that does not require an operation by an operator is included in the processes for producing the product based on the order data.

9. The method according to claim 8, the method further comprising, issuing an instruction to prioritize processing of a specific process ahead of products that are based on other order data if the specific process of a product for which a production instruction has been issued is not completed.

10. The method according to claim 9, the method further comprising, issuing an instruction to prioritize a specific process having the earliest planned start time for the next process if there is a plurality of orders for which a production instruction has been issued and the specific process is not completed.

11. The method according to claim 8, the method further comprising determining whether a process that does not require an operation by an operator is included by acquiring process information corresponding to product information about the order data in the registering.

12. The method according to claim 8, the method further comprising issuing an instruction for a prepress process in the registering.

13. The method according to claim 8, the method further comprising cancelling execution of a process for a product for which a production instruction has already been issued if registration of the order data is unsuccessful in the registering.

14. The method according to claim 8, further comprising, not deleting content data for processes that have already been completed if cancellation was performed by the order management method.

15. A computer-readable storage medium storing a program that causes a computer to execute an order management method for handling a product order in which processing content of a plurality of processes is defined, the method comprising:
receiving order data;
registering the received order data; and
issuing an instruction to produce a product based on the registered order data according to scheduling performed by an administrator,
issuing an instruction to start a process with production of the product based on the order data removed from a target of the scheduling if the process that does not require an operation by an operator is included in the processes for producing the product based on the order data.
